(19) United States
(12) Patent Application Publication
(10) Pub. No.: US 2024/0356147 A1
(43) Pub. Date: Oct. 24, 2024

(54) BATTERY UNIT

(71) Applicant: SUBARU CORPORATION, Tokyo (JP)

(72) Inventors: Yutaka YOKOYAMA, Tokyo (JP); Shota TOCHIGANE, Tokyo (JP)

(73) Assignee: SUBARU CORPORATION, Tokyo (JP)

(21) Appl. No.: 18/762,180

(22) Filed: Jul. 2, 2024

Related U.S. Application Data
(63) Continuation of application No. PCT/JP2023/013194, filed on Mar. 30, 2023.

(51) Int. Cl. H01M 50/296; B60K 1/02; B60R 16/023; B60R 16/033; H01M 50/209; H01M 50/249; H01M 50/574

(52) U.S. Cl. CPC H01M 50/296; B60K 1/02; B60R 16/0238; B60R 16/033; H01M 50/209; H01M 50/249; H01M 50/574; H01M 2220/20

(57) ABSTRACT

A battery unit includes: a battery; a battery case accommodating the battery; front and rear junction boxes provided on front and rear sides, respectively, in a front-rear direction of a vehicle and configured to distribute electric power to front and rear motors, respectively; front and rear bus bars coupling a corresponding one of a positive electrode terminal and a negative electrode terminal of the battery to the front and rear junction boxes, respectively; a center bus bar coupling the front and the rear junction boxes to each other; an electrical device disposed above the center bus bar; and a cooling plate disposed between the center bus bar and the electrical device to cool the electrical device. The front and rear junction boxes, the front rear, and center bus bars, the electrical device, and the cooling plate are disposed on or above a top of the battery case.

### CROSS REFERENCES TO RELATED APPLICATIONS

This application is continuation of International Application No. PCT/JP2023/013194, filed on Mar. 30, 2023, the entire contents of which are hereby incorporated by reference.

### BACKGROUND

### Technical Field

The present disclosure relates to a battery unit to be provided in a vehicle.

### Related Art

A vehicle has been proposed in which electric connection boxes are provided in front of and behind a battery, electric power is supplied from the battery to a front motor via the front electric connection box, and electric power is supplied from the battery to a rear motor via the rear electric connection box (for example, Japanese Unexamined Patent Application Publication No. 2020-90234).

### SUMMARY

An aspect of the disclosure provides a battery unit including a battery, a battery case, a front junction box, a rear junction box, a front bus bar, a rear bus bar, a center bus bar, an electrical device, and a cooling plate. The battery case accommodates the battery. The front junction box is provided on a front side in a front-rear direction of a vehicle and configured to distribute electric power to a front motor. The rear junction box is provided on a rear side in the front-rear direction and configured to distribute electric power to a rear motor. The front bus bar is couples the front junction box and one of a positive electrode terminal and a negative electrode terminal of the battery to each other. The rear bus bar couples the rear junction box and another one of the positive electrode terminal and the negative electrode terminal of the battery to each other. The center bus bar couples the front junction box and the rear junction box to each other. The electrical device is disposed above the center bus bar. The cooling plate is disposed between the center bus bar and the electrical device and configured to cool the electrical device. The front junction box, the rear junction box, the front bus bar, the rear bus bar, the center bus bar, the electrical device, and the cooling plate are disposed on or above a top of the battery case.

### BRIEF DESCRIPTION OF THE DRAWINGS

FIG. 1 is a diagram illustrating a configuration of a vehicle;

FIG. 2 is an exploded perspective view illustrating a configuration of a battery module;

FIG. 3 is a diagram illustrating a configuration of a front junction box and a rear junction box;

FIG. 4 is a diagram illustrating an electrical configuration of the front junction box and the rear junction box;

FIG. 5 is a diagram illustrating a coupling relationship between a center bus bar, a system main relay, and the front junction box; and

FIG. 6 is a diagram illustrating a modification of a coupling relationship between the center bus bar and the front junction box.

### DETAILED DESCRIPTION

In the vehicle described above, a positive electrode terminal and a negative electrode terminal of a battery are coupled to one of the electric connection boxes. In such a case, for example, when the vehicle collides and the electric connection box to which the positive electrode terminal and the negative electrode terminal are coupled is damaged, the battery may be short-circuited.

Therefore, it is desirable to reduce the short-circuiting of the battery.

### 1. General Configuration of Vehicle

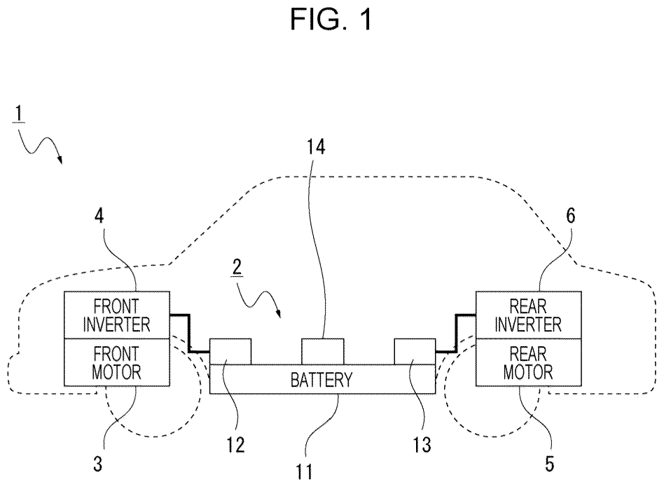

FIG. 1 is a diagram illustrating a configuration of a vehicle 1. Hereinafter, a front-rear direction of the vehicle 1 is simply referred to as a front-rear direction. In addition, a left-right direction of the vehicle 1 is simply referred to as a left-right direction.

As illustrated in FIG. 1, the vehicle 1 is an electric vehicle including a battery module 2, a front motor 3, a front inverter 4, a rear motor 5, and a rear inverter 6.

The battery module 2 is disposed, for example, at the center in the front-rear direction and below the floor. As will be described in detail later, the battery module 2 includes a battery 11, a front junction box 12, a rear junction box 13, and an electrical device 14.

The battery 11 can store electric power (electricity) to be supplied to the front motor 3 and the rear motor 5.

The front junction box 12 is coupled to the battery 11 and the front inverter 4, and distributes the electric power from the battery 11 to the front motor 3 via the front inverter 4.

The rear junction box 13 is coupled to the battery 11 and the rear inverter 6, and distributes the electric power from the battery 11 to the rear motor 5 via the rear inverter 6.

The electrical device 14 is, for example, a DC-DC converter that generates a voltage of 100 V, an on-board charger (OBC) that can be coupled to an external charging device, or the like, and is coupled to the battery 11.

The front motor 3 and the rear motor 5 are power sources for allowing the vehicle 1 to travel, and are, for example, three phase AC motors.

The front motor 3 is coupled to front wheels. The front motor 3 generates a driving force when the electric power is supplied from the battery 11 via the front junction box 12 and the front inverter 4, and transmits the driving force to the front wheels to rotate the front wheels.

The rear motor 5 is coupled to rear wheels. The rear motor 5 generates a driving force when the electric power is supplied from the battery 11 via the rear junction box 13 and the rear inverter 6, and transmits the driving force to the rear wheels to rotate the rear wheels.

The front motor 3 and the rear motor 5 generate electricity (electric power) by performing a regenerative operation. The electricity generated by the regenerative operation of the front motor 3 and the rear motor 5 is supplied to the battery 11 via the front inverter 4 and the rear inverter 6, respectively, to charge the battery 11.

The front inverter 4 converts a direct current supplied from the battery 11 into a three phase alternating current and supplies the three phase alternating current to the front motor 3. In addition, when the front motor 3 performs the regenerative operation, the front inverter 4 converts an alternating current supplied from the front motor 3 into a direct current and supplies the direct current to the battery 11 to charge the battery 11.

The rear inverter 6 converts a direct current supplied from the battery 11 into a three phase alternating current and supplies the three phase alternating current to the rear motor 5. In addition, when the rear motor 5 performs the regenerative operation, the rear inverter 6 converts an alternating current supplied from the rear motor 5 into a direct current and supplies the direct current to the battery 11 to charge the battery 11.

### 2. Configuration of Battery Module 2

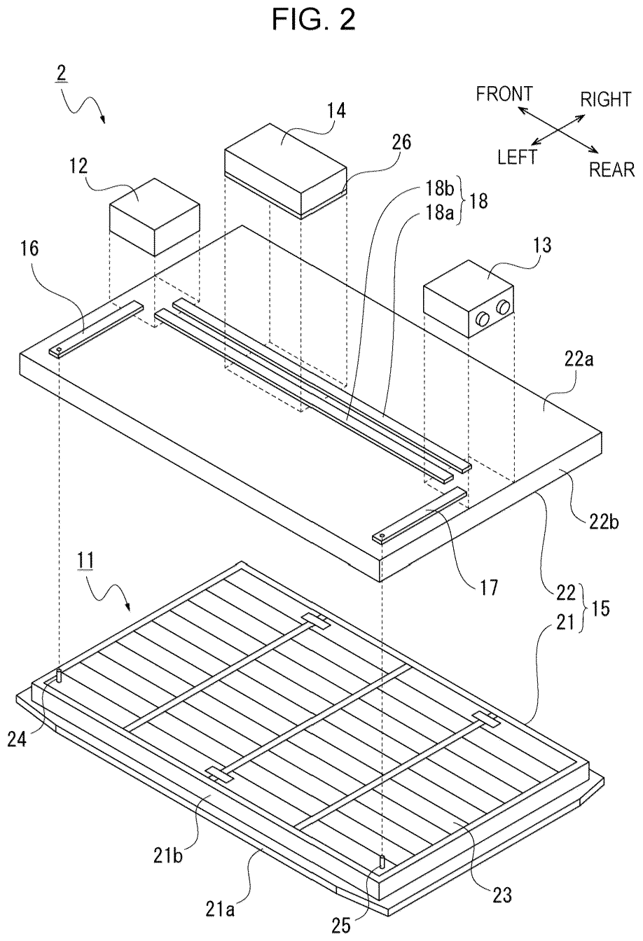

FIG. 2 is an exploded perspective view illustrating a configuration of the battery module 2. As illustrated in FIG. 2, the battery module 2 includes the battery 11, the front junction box 12, the rear junction box 13, and the electrical device 14. The battery module 2 further includes a battery case 15, a front bus bar 16, a rear bus bar 17, and a center bus bar 18.

The battery case 15 includes a battery tray 21 and a battery cover 22.

The battery tray 21 is formed of, for example, an iron material or an aluminum material. In the battery tray 21, a bottom 21a and a frame 21b are permanently affixed to each other. The bottom 21a is flat and serves as a bottom. The frame 21b protrudes upward from the bottom 21a so as to have a substantially rectangular frame shape. A space surrounded by the bottom 21a and the frame 21b serves as an accommodating space for accommodating the battery 11.

The battery cover 22 is formed of, for example, a resin material or an aluminum material. In the battery cover 22, a top 22a and a frame 22b are permanently affixed to each other. The top 22a is flat and serves as a top. The frame 22b protrudes downward from the top 22a so as to have a substantially rectangular frame shape.

The battery case 15 is accommodated in a space surrounded by the top 22a and the frame 22b of the battery cover 22 so as to cover the frame 21b of the battery tray 21. That is, the battery case 15 covers the battery 11 with the battery tray 21 and the battery cover 22 without exposing the battery 11 to the outside.

Here, the battery 11 includes battery cells 23. Each of the battery cells 23 is, for example, a lithium ion battery or the like, and can be used by repeating charging and discharging.

The battery cells 23 are formed in a substantially rectangular parallelepiped shape, and are arranged side by side in the front-rear direction and the left-right direction in the battery case 15. The length of the battery cells 23 in an up-down direction, that is, the height of the battery cells 23, is substantially equal to the length of the frame 21b of the battery tray 21 in the up-down direction.

Among the battery cells 23 disposed in the battery case 15, adjacent battery cells 23 are connected in series with each other. Thus, the battery 11 can supply a high-voltage electric power of, for example, 200 V or 400 V.

Among the battery cells 23 connected in series, the battery cell 23 disposed closest to a positive electrode in a series direction is provided with a positive electrode terminal 24. In addition, among the battery cells 23 connected in series, the battery cell 23 disposed closest to a negative electrode in the series direction is provided with a negative electrode terminal 25.

Each of the positive electrode terminal 24 and the negative electrode terminal 25 is provided for the battery cells 23 so as to protrude upward.

Through holes (not illustrated) are formed in the top 22a of the battery cover 22 at positions facing the positive electrode terminal 24 and the negative electrode terminal 25.

When the battery cells 23 are accommodated in the battery case 15, the positive electrode terminal 24 and the negative electrode terminal 25 are inserted into the through holes formed in the top 22a of the battery cover 22 and protrude upward from the top 22a.

The front junction box 12, the rear junction box 13, the electrical device 14, the front bus bar 16, the rear bus bar 17, and the center bus bar 18 are provided on or above the top 22a.

The front junction box 12 is disposed on the front side of the top 22a in the front-rear direction and at the center in the left-right direction. At this time, the front junction box 12 is disposed so as to be entirely accommodated inside the outer edge of the battery case 15.

The rear junction box 13 is disposed on the rear side of the top 22a in the front-rear direction and at the center in the left-right direction. At this time, the rear junction box 13 is disposed so as to be entirely accommodated inside the outer edge of the battery case 15.

The front bus bar 16 is disposed on the front side of the top 22a in the front-rear direction and along the left-right direction such that both ends of the front bus bar 16 are coupled to the positive electrode terminal 24, which protrudes upward from the top 22a, and the front junction box 12. Note that the front bus bar 16 is insulated from the outside by being covered with, for example, a resin material.

The rear bus bar 17 is disposed on the rear side of the top 22a in the front-rear direction and along the left-right direction such that both ends of the rear bus bar 17 are coupled to the negative electrode terminal 25, which protrudes upward from the top 22a, and the rear junction box 13. Note that the rear bus bar 17 is insulated from the outside by being covered with, for example, a resin material.

The center bus bar 18 is constituted by a positive-electrode center bus bar 18a and a negative-electrode center bus bar 18b.

The positive-electrode center bus bar 18a and the negative-electrode center bus bar 18b are disposed at the center of the top 22a in the left-right direction and along the front-rear direction such that both ends of the positive-electrode center bus bar 18a and the negative-electrode center bus bar 18b are coupled to the front junction box 12 and the rear junction box 13. Note that the positive-electrode center bus bar 18a and the negative-electrode center bus bar 18b are insulated from the outside by being covered with, for example, a resin material. In addition, the positive-electrode center bus bar 18a and the negative-electrode center bus bar 18b are disposed substantially parallel to each other with a predetermined space therebetween.

The electrical device 14 is disposed at the center of the top 22a in the front-rear direction and the left-right direction above the center bus bar 18 with a cooling plate 26 interposed therebetween. As will be described in detail later, the electrical device 14 is coupled to each of the positive-electrode center bus bar 18a and the negative-electrode center bus bar 18b.

The cooling plate 26 has, for example, a structure in which a cooling medium flows therein, and cools the electrical device 14 disposed thereabove. In addition, the cooling plate 26 is disposed so as to abut on the center bus bar 18, thereby cooling the center bus bar 18.

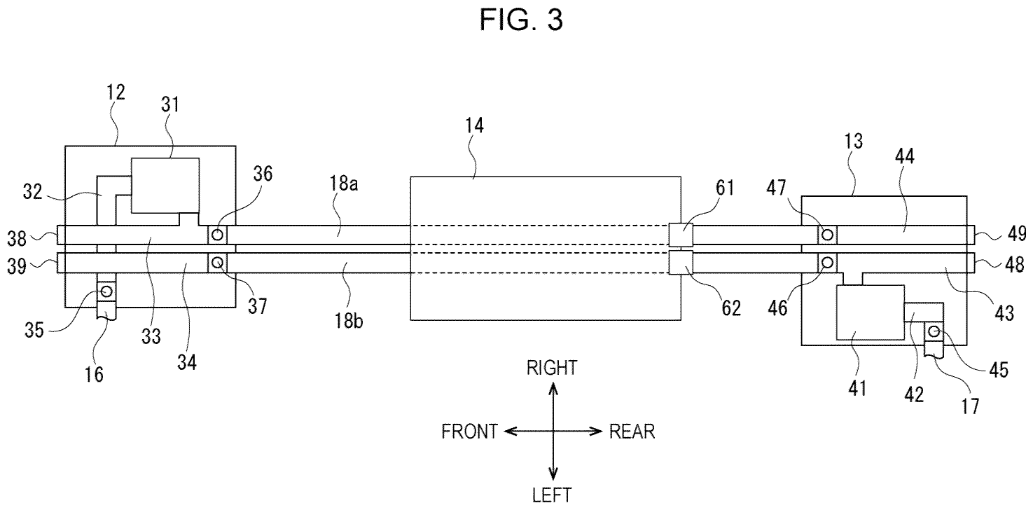

FIG. 3 is a diagram illustrating a configuration of the front junction box 12 and the rear junction box 13. In FIG. 3, a part of the configuration of the battery module 2 is illustrated, and a part of the configuration of the front junction box 12 and the rear junction box 13 is omitted.

As illustrated in FIG. 3, the front junction box 12 includes a system main relay 31, a first front internal bus bar 32, a second front internal bus bar 33, a third front internal bus bar 34, fastening members 35, 36, and 37, and connectors 38 and 39.

One end of the first front internal bus bar 32 is coupled to the front bus bar 16 via the fastening member 35, and the other end thereof is coupled to the system main relay 31.

The second front internal bus bar 33 is formed so as to be divided into three directions. A first end of the second front internal bus bar 33 is coupled to the system main relay 31, a second end thereof is coupled to the positive-electrode center bus bar 18a via the fastening member 36, and a third end thereof is coupled to the connector 38. Note that the first front internal bus bar 32 and the second front internal bus bar 33 can be electrically connected to each other by the system main relay 31.

One end of the third front internal bus bar 34 is coupled to the negative-electrode center bus bar 18b via the fastening member 37, and the other end thereof is coupled to the connector 39.

The system main relay 31 is configured to be able to electrically connect and disconnect the positive electrode terminal 24 of the battery 11, which is coupled via the front bus bar 16, the fastening member 35, and the first front internal bus bar 32, to and from the second front internal bus bar 33.

The fastening members 35, 36, and 37 are constituted by, for example, bolts and nuts made of conductive metal members, and fasten the pair of bus bars.

The connectors 38 and 39 are coupled to the front inverter 4.

The rear junction box 13 includes a system main relay 41, a first rear internal bus bar 42, a second rear internal bus bar 43, a third rear internal bus bar 44, fastening members 45, 46, and 47, and connectors 48 and 49.

One end of the first rear internal bus bar 42 is coupled to the rear bus bar 17 via the fastening member 45, and the other end thereof is coupled to the system main relay 41.

The second rear internal bus bar 43 is formed so as to be divided into three directions. A first end of the second rear internal bus bar 43 is coupled to the system main relay 41, a second end thereof is coupled to the negative-electrode center bus bar 18b via the fastening member 46, and a third end thereof is coupled to the connector 48. Note that the first rear internal bus bar 42 and the second rear internal bus bar 43 can be electrically connected to each other in the system main relay 41.

One end of the third rear internal bus bar 44 is coupled to the positive-electrode center bus bar 18a via the fastening member 47, and the other end thereof is coupled to the connector 49.

The system main relay 41 is configured to be able to electrically connect and disconnect the negative electrode terminal 25 of the battery 11, which is coupled via the rear bus bar 17, the fastening member 45, and the first rear internal bus bar 42, to and from the second rear internal bus bar 43.

The fastening members 45, 46, and 47 are constituted by, for example, bolts and nuts made of conductive metal members, and fasten the pair of bus bars.

The connectors 48 and 49 are coupled to the rear inverter 6.

The electrical device 14 is provided with connectors 61 and 62. The electrical device 14 is coupled to the positive-electrode center bus bar 18a via the connector 61, and is coupled to the negative-electrode center bus bar 18b via the connector 62.

Thus, the battery 11 and the electrical device 14 can be coupled to each other without newly providing electric wiring for coupling the battery 11 and the electrical device 14 to each other, the number of components can be reduced, and the size can be reduced.

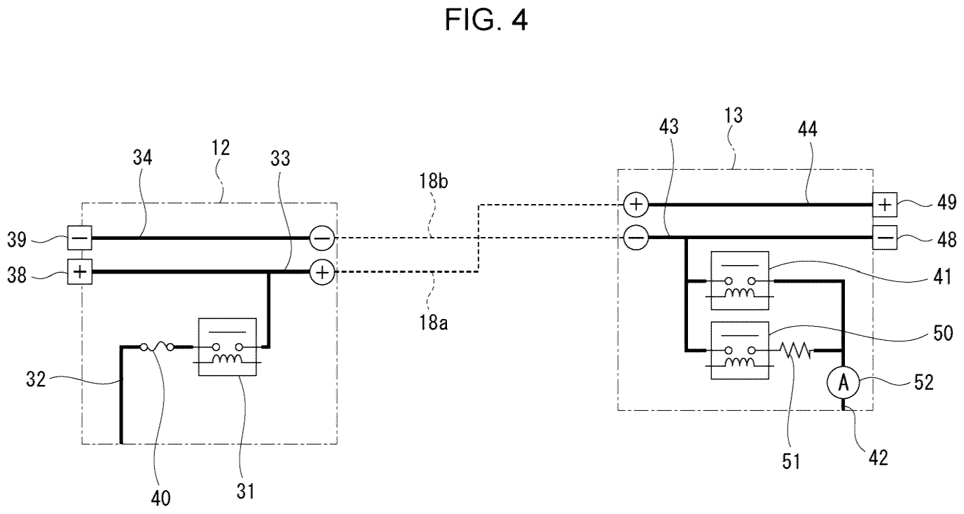

FIG. 4 is a diagram illustrating an electrical configuration of the front junction box 12 and the rear junction box 13. Note that FIG. 4 illustrates a part of the configuration of the battery module 2. In addition, in FIG. 4, for convenience of description, the positive-electrode center bus bar 18a and the negative-electrode center bus bar 18b are made to intersect with each other in the middle.

As illustrated in FIG. 4, the front junction box 12 includes a fuse 40 in addition to the system main relay 31. The system main relay 31 and the fuse 40 are connected in series between the first front internal bus bar 32 and the second front internal bus bar 33.

The system main relay 31 can electrically connect and disconnect the first front internal bus bar 32 and the second front internal bus bar 33 to and from each other, and is controlled by an electronic control unit (ECU) (not illustrated).

The fuse 40 is broken when an overcurrent flows, and disconnects the first front internal bus bar 32 and the second front internal bus bar 33 from each other.

The rear junction box 13 includes a relay 50, a resistor 51, and an ammeter 52 in addition to the system main relay 41.

The system main relay 41 and the relay 50 are connected in parallel between the first rear internal bus bar 42 and the second rear internal bus bar 43.

The resistor 51 is connected in series to the relay 50, and is connected in parallel to the system main relay 41.

The ammeter 52 is disposed closer to the first rear internal bus bar 42 than the system main relay 41, the relay 50, and the resistor 51, and measures a current value of current flowing through the first rear internal bus bar 42.

The system main relay 41 and the relay 50 can electrically connect and disconnect the first rear internal bus bar 42 and the second rear internal bus bar 43 to and from each other, and are controlled by the ECU (not illustrated).

The ECU electrically connects the first front internal bus bar 32 and the second front internal bus bar 33 to each other by turning on the system main relay 31. In addition, the ECU electrically connects the first rear internal bus bar 42 and the second rear internal bus bar 43 to each other by turning on the system main relay 41. Furthermore, the ECU electrically connects the first rear internal bus bar 42 and the second rear internal bus bar 43 to each other via the resistor 51 by turning on the relay 50.

Then, the positive electrode terminal 24 of the battery 11 is coupled to the front motor 3 via the front bus bar 16, the fastening member 35, the first front internal bus bar 32, the system main relay 31, the second front internal bus bar 33, the connector 38, and the front inverter 4. In addition, the negative electrode terminal 25 of the battery 11 is coupled to the front motor 3 via the rear bus bar 17, the fastening member 45, the first rear internal bus bar 42, the system main relay 41, the second rear internal bus bar 43, the fastening member 46, the negative-electrode center bus bar 18b, the fastening member 37, the third front internal bus bar 34, the connector 39, and the front inverter 4. Thus, the electric power from the battery 11 is supplied to the front motor 3.

In addition, the positive electrode terminal 24 of the battery 11 is coupled to the rear motor 5 via the front bus bar 16, the fastening member 35, the first front internal bus bar 32, the system main relay 31, the second front internal bus bar 33, the fastening member 36, the positive-electrode center bus bar 18a, the fastening member 47, the third rear internal bus bar 44, the connector 49, and the rear inverter 6. Furthermore, the negative electrode terminal 25 of the battery 11 is coupled to the rear motor 5 via the rear bus bar 17, the fastening member 45, the first rear internal bus bar 42, the system main relay 41, the second rear internal bus bar 43, the connector 48, and the rear inverter 6. Thus, the electric power from the battery 11 is supplied to the rear motor 5.

Similarly, in the battery module 2, the battery 11 and the electrical device 14 can be electrically connected to each other.

On the other hand, the ECU electrically disconnects the first front internal bus bar 32 and the second front internal bus bar 33 from each other by turning off the system main relay 31, for example, when a voltage value measured by the ammeter 52 is greater than or equal to a predetermined threshold value or when a collision of the vehicle 1 is detected. Also, the ECU electrically connects the first rear internal bus bar 42 and the second rear internal bus bar 43 to each other by turning off the system main relay 41 and the relay 50. Thus, the ECU electrically disconnects the front motor 3, the rear motor 5, and the electrical device 14 from the battery 11.

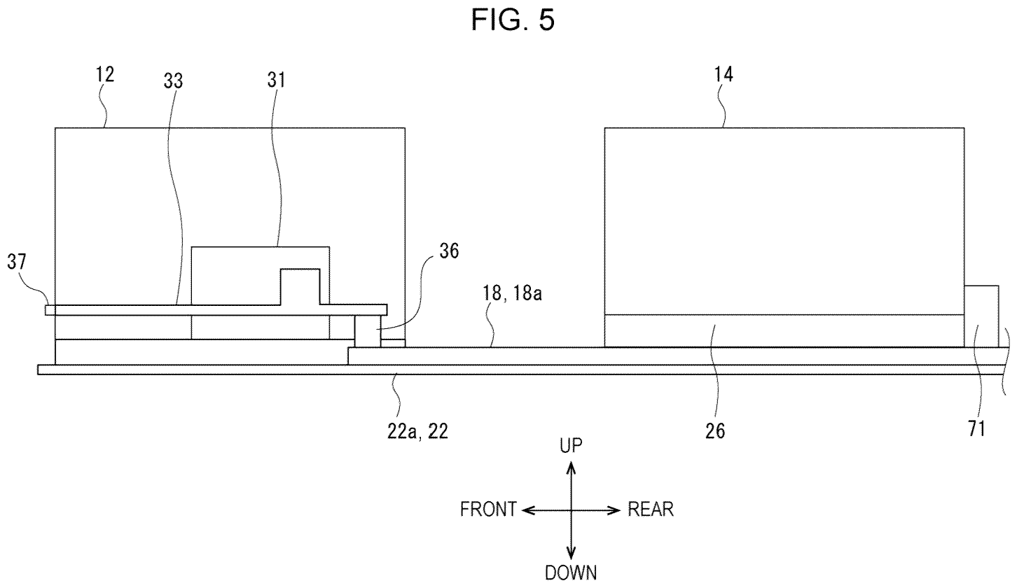

FIG. 5 is a diagram illustrating a coupling relationship between the center bus bar 18, the system main relay 31, and the front junction box 12. Note that FIG. 5 illustrates a part of the configuration of the front junction box 12 and the electrical device 14, and illustrates the positive-electrode center bus bar 18a. Other configurations are omitted.

As illustrated in FIG. 5, the center bus bar 18 (the positive-electrode center bus bar 18a in the drawing) is disposed so as to be in close contact with an upper surface of the top 22a. In this case, for example, one end of the positive-electrode center bus bar 18a is inserted into a position immediately above the second end of the second front internal bus bar 33 in the front junction box 12. The one end of the positive-electrode center bus bar 18a and the second end of the second front internal bus bar 33 are fastened by the fastening member 36 and electrically connected to each other.

In this manner, heat generated in the system main relay 31 can be transferred to the positive-electrode center bus bar 18a in the battery module 2. Since the positive-electrode center bus bar 18a is in close contact with the battery cover 22 (top 22a), heat generated in the system main relay 31 can be released to the battery cover 22 when the battery cover 22 is made of a material having high heat conductivity (for example, an aluminum material).

The cooling plate 26 is disposed so as to be abut on the center bus bar 18. Thus, the cooling plate 26 can cool not only the electrical device 14 but also the center bus bar 18.

### 3. Modification

Note that the above-described embodiment is an example for carrying out the present disclosure, and carrying out of the present disclosure is not limited to the above-described example, and various modifications can be considered.

For example, in the above-described embodiment, the front junction box 12 and the positive electrode terminal 24 of the battery 11 are coupled to each other by the front bus bar 16. However, the front junction box 12 and the negative electrode terminal 25 of the battery 11 may be coupled to each other by the front bus bar 16. In this case, the negative electrode terminal 25 is to be provided on the front side.

In the above-described embodiment, the rear junction box 13 and the negative electrode terminal 25 of the battery 11 are coupled to each other by the rear bus bar 17. However, the rear junction box 13 and the positive electrode terminal 24 of the battery 11 may be coupled to each other by the rear bus bar 17. In this case, the positive electrode terminal 24 is to be provided on the rear side.

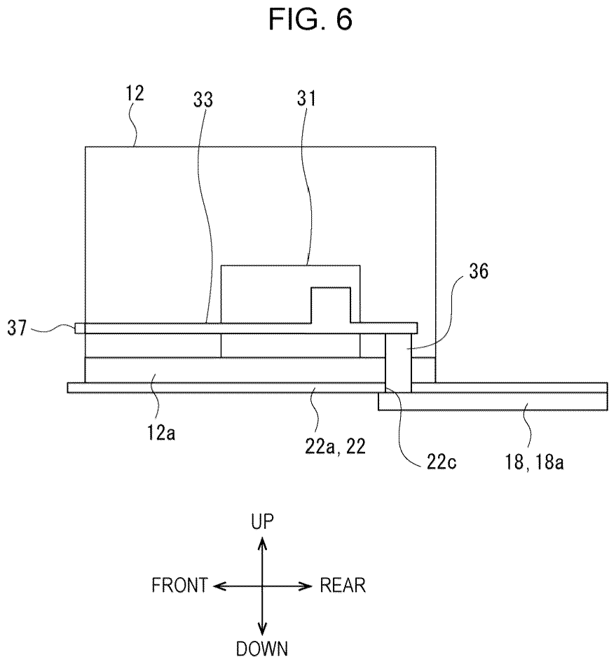

In the above-described embodiment, the center bus bar 18 is disposed on the upper surface of the top 22a. However, as illustrated in FIG. 6, the center bus bar 18 may be disposed to be in close contact with a lower surface of the top 22a. In this case, for example, the positive-electrode center bus bar 18a is disposed inside the battery case 15 such that one end of the positive-electrode center bus bar 18a is positioned immediately below the second end of the second front internal bus bar 33 in the front junction box 12. Then, the one end of the positive-electrode center bus bar 18a and the second end of the second front internal bus bar 33 may be fastened and electrically connected to each other by the fastening member 36 inserted into a through hole 22c formed in the top 22a.

In this way, the heat generated in the system main relay 31 can be released to the battery cover 22 as in the case illustrated in FIG. 5. In addition, for example, even when an external force is applied to the battery module 2 due to a collision of the vehicle 1 or the like, since the center bus bar 18 is accommodated in the battery case 15, it is possible to reduce the possibility that the center bus bar 18 is deformed or damaged.

### 4. Conclusion

As described above, the battery module 2 of the embodiment includes the battery 11, the battery case 15, the front junction box 12, the rear junction box 13, the front bus bar 16, the rear bus bar 17, and the center bus bar 18. The battery case 15 accommodates the battery 11. The front junction box 12 is provided on the front side in the front-rear direction of the vehicle 1 and distributes the electric power to the front motor 3. The rear junction box 13 is provided on the rear side in the front-rear direction and distributes the electric power to the rear motor 5. The front bus bar 16 couples the front junction box 12 and one of the positive electrode terminal 24 and the negative electrode terminal 25 of the battery 11 to each other. The rear bus bar 17 couples the rear junction box 13 and the other of the positive electrode terminal 24 and the negative electrode terminal 25 of the battery 11 to each other. The center bus bar 18 couples the front junction box 12 and the rear junction box 13 to each other.

Accordingly, in the battery module 2, the positive electrode terminal 24 and the negative electrode terminal 25 of the battery 11 are coupled to the front junction box 12 and the rear junction box 13, respectively.

That is, in the battery module 2, a positive electrode and a negative electrode of the battery 11 are coupled to different junction boxes.

Accordingly, even when any of the bus bars is deformed or damaged due to a collision or the like, an electric circuit in which the positive electrode and the negative electrode of the battery 11 are connected to each other is unlikely to be formed. Therefore, the battery module 2 can reduce the possibility that the battery 11 is short-circuited.

In addition, since the front junction box 12 and the rear junction box 13 are disposed so as to be spaced apart from each other in the front-rear direction, there is a low possibility that the front junction box 12 and the rear junction box 13 are simultaneously damaged by a collision or the like. Even if, for example, the front bus bar 16 is pushed into the front junction box 12 due to a collision or the like, the electric circuit is disconnected by the other rear junction box 13 (the system main relay 41 and the relay 50). Accordingly, the battery module 2 can reduce the possibility that the battery 11 is short-circuited.

The front junction box 12, the rear junction box 13, the front bus bar 16, the rear bus bar 17, and the center bus bar 18 are disposed on or above the top 22a of the battery case 15.

Since the battery case 15 is formed to be strong enough to withstand a collision or the like, by disposing these configurations on or above the top 22a, it is possible to reduce the possibility that these configurations are deformed or damaged due to an external force of a collision or the like.

In this manner, the battery module 2 can further reduce the possibility that the battery 11 is short-circuited.

The front junction box 12 and the rear junction box 13 are disposed so as to be entirely accommodated inside the outer edge of the battery case 15.

Accordingly, when an external force of a collision or the like is applied, the front junction box 12 and the rear junction box 13 are protected by the battery case 15, which is made strong.

In this manner, the battery module 2 can further reduce the possibility that the battery 11 is short-circuited.

The center bus bar 18 is disposed on the top 22a at the center in the left-right direction of the vehicle 1.

Accordingly, it is possible to reduce the possibility that the center bus bar 18 is deformed or damaged due to a collision or the like, and it is possible to couple the front junction box 12 and the rear junction box 13 to each other at the shortest distance.

The battery module 2 includes the electrical device 14 and the cooling plate 26. The electrical device 14 is disposed above the center bus bar 18. The cooling plate 26 is disposed between the center bus bar 18 and the electrical device 14 to cool the electrical device 14.

Accordingly, heat generated in the front junction box 12 and the rear junction box 13 can be cooled by the cooling plate 26 via the center bus bar 18. By cooling the center bus bar 18 with the cooling plate 26, an increase in a cross-sectional area of the center bus bar 18 can be suppressed, and the front junction box 12 and the rear junction box 13 can be reduced in size.

According to the present disclosure, the short-circuiting of the battery can be reduced.

1. A battery unit comprising:
a battery;
a battery case accommodating the battery;
a front junction box provided on a front side in a front-rear direction of a vehicle, the front junction box being configured to distribute electric power to a front motor;
a rear junction box provided on a rear side in the front-rear direction, the rear junction box being configured to distribute electric power to a rear motor;
a front bus bar coupling the front junction box and one of a positive electrode terminal and a negative electrode terminal of the battery to each other;
a rear bus bar coupling the rear junction box and another one of the positive electrode terminal and the negative electrode terminal of the battery to each other;
a center bus bar coupling the front junction box and the rear junction box to each other;
an electrical device disposed above the center bus bar; and
a cooling plate disposed between the center bus bar and the electrical device, the cooling plate being configured to cool the electrical device, wherein
the front junction box, the rear junction box, the front bus bar, the rear bus bar, the center bus bar, the electrical device, and the cooling plate are disposed on or above a top of the battery case.

2. The battery unit according to claim 1, wherein the front junction box and the rear junction box are disposed so as to be entirely accommodated inside an outer edge of the battery case.

3. The battery unit according to claim 1, wherein the center bus bar is disposed on the top at a center in a left-right direction of the vehicle.

4. The battery unit according to claim 1, wherein
the front junction box comprises a first system main relay configured to electrically connect and disconnect the one of the positive electrode terminal and the negative electrode terminal; and
the rear junction box comprises a second system main relay configured to electrically connect and disconnect the another one of the positive electrode terminal and the negative electrode terminal.

5. The battery unit according to claim 2, wherein
the front junction box comprises a first system main relay configured to electrically connect and disconnect the one of the positive electrode terminal and the negative electrode terminal; and
the rear junction box comprises a second system main relay configured to electrically connect and disconnect the another one of the positive electrode terminal and the negative electrode terminal.

6. The battery unit according to claim 3, wherein
the front junction box comprises a first system main relay configured to electrically connect and disconnect the one of the positive electrode terminal and the negative electrode terminal; and
the rear junction box comprises a second system main relay configured to electrically connect and disconnect the another one of the positive electrode terminal and the negative electrode terminal.
